(19) United States
(12) Patent Application Publication
(10) Pub. No.: US 2014/0077051 A1
(43) Pub. Date: Mar. 20, 2014

(54) SUPPORT FOR SUSPENDING BALLOONS

(71) Applicant: José Alberto PEREIRA FONSECA, Lamego (PT)

(72) Inventor: José Alberto PEREIRA FONSECA, Lamego (PT)

(21) Appl. No.: 14/031,532

(22) Filed: Sep. 19, 2013

(30) Foreign Application Priority Data
Sep. 19, 2012 (PT) 106544

(51) Int. Cl. F16M 13/02

(52) U.S. Cl. CPC F16M 13/02
USPC 248/317

(57) ABSTRACT

The present invention relates to a support for suspending balloons (5). It is characterized in that it is formed by: a body (1) substantially cylindrical whose outer and inner parts are threaded, the lower end being fully open and the upper end being closed; two adjacent holes (3, 4) on the upper end; two diametrically opposed holes (6, 7) on the upper end; a stretch yarn (2) fixed to the body (1) by its upper end through said holes (3, 4) and in which the lower end is tied to the mouth of the balloon (5). The balloon (5), once filled, closed and tied with said stretch yarn (2), will be accommodated on the open lower end of the body (1).

The present invention relates to a support for suspending balloons which in addition to its main function of suspending balloons also has a decorative function.

Typically balloons are filled with a gas, in particular helium, which is lighter than air making them rise. Such balloons are closed by its tip and given its upward trend they can float at any height when held by suitable means.

With this invention, it is not necessary to use any gas lighter than air for suspending the balloons at any height.

It is then an object of the invention to design a balloon support that is able to suspend them at any height.

The present invention therefore provides a support for balloons according to claim 1. Preferred features of the invention are further provided according to the dependent claims.

In order to facilitate its understanding the following description is based on the accompanying drawings, in which:

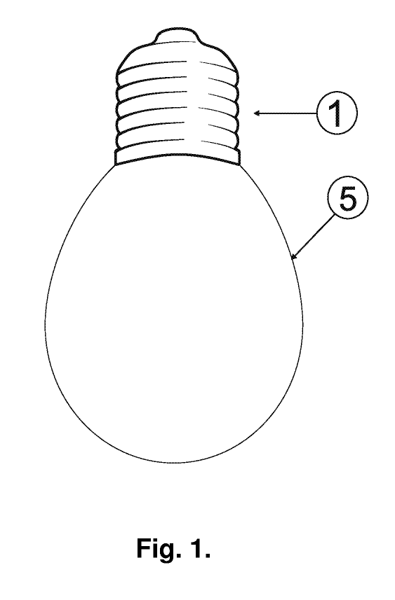

FIG. 1 is a schematic view of the balloon properly mounted on the support; and

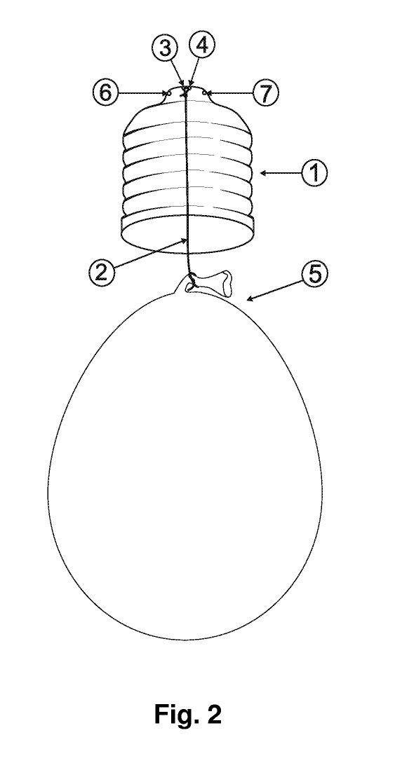

FIG. 2 is a schematic exploded view of the support and balloon shown in FIG. 1.

As can be seen the support for balloons which is the object of the invention is formed by a body (1) substantially cylindrical whose outer and inner parts are threaded, the lower end being fully open and the upper end being closed. With this embodiment it is intended to match the configuration of the body (1) to a lamp cap.

Said body (1) has two adjacent orifices (3, 4) at the top of its bell-shaped upper end and another two diametrically opposed holes (6, 7) at the surface of said upper end.

The support also comprises a stretch yarn (2) fixed to the body (1) by its upper end through said holes (3, 4) the lower end intending to be tied through a knot to close the mouth of the balloon (5) when filled.

As can easily be understood, said stretch yarn (2) has a shorter length than the height of the body (1). This enables the balloon to be perfectly coupled with the lower end of the body (1) once it is filled. As a matter of fact, given that the stretch yarn (2) must be previously stretched in order to be used in closing the mouth of the filled balloon, once said stretch yarn is released it will return to its original length and will pull the balloon to the lower end of the body (1).

As mentioned above the body (1) is provided with two holes (6, 7). These holes will allow the support to be suspended by suitable means, for example a simple wire, at any height. For this purpose, it is enough to pass the suspension means through the holes (6, 7) and fix the same means accordingly.

The balloon being attached to the support (1) which in turn is suspended by appropriate means will have a configuration very similar to a light bulb. From this fact several ornamental effects can result, eventually by mixing balloons of various colors.

As follows from the previously described it is possible to use balloons of various diameters and shapes with the same support in indoor and outdoor environments.

Such support is preferably made from plastics.

The present invention should only be limited by the features presented in the appended claims.

1. A support for suspending balloons (5) having a mouth, comprising:
a body (1) that is substantially cylindrical and having outer and inner parts that are threaded, a lower end being fully open and an upper end being closed;
two adjacent holes (3, 4) on the upper end;
two diametrically opposed holes (6, 7) on the upper end;
a stretch yarn (2) fixed to the body (1) by its upper end through said holes (3, 4) and in which the lower end is tied to the mouth of the balloon (5).

2. The support for suspending balloons (5) according to claim 1, characterized in that the balloon (5) once filled and tied through a knot by said stretch yarn (2) will be accommodated on the open lower end of the body (1).

3. The support for suspending balloons (5) according to claim 1, characterized in that said stretch yarn has a shorter length than a height of the body (1).

4. The support for suspending balloons (5) according to claim 1, characterized in that said stretch yarn (2) is previously stretched before closing the mouth of the balloon (5), returning to its original length once released together with the balloon.

5. The support for suspending balloons (5) according to claim 1, characterized in that the body (1) is suspended by suspension means which pass through said diametrically opposed holes (6, 7).

6. The support for suspending balloons (5) according to claim 5, characterized in that the suspension means of the body (1) is a wire.
